(19) United States
(12) Patent Application Publication
(10) Pub. No.: US 2024/0132637 A1
(43) Pub. Date: Apr. 25, 2024

(54) NON-FLUORINATED POLYMER PROCESSING AIDS

(71) Applicant: FINA TECHNOLOGY, INC., Houston, TX (US)

(72) Inventors: Fengkui Li, Houston, TX (US); Joachim Azzi, Houston, TX (US); Mohammad Tuhin, Houston, TX (US); Andy Culkin, League City, TX (US)

(73) Assignee: FINA TECHNOLOGY, INC., Houston, TX (US)

(21) Appl. No.: 17/963,644

(22) Filed: Oct. 11, 2022

(51) Int. Cl. C08F 10/02; B29C 48/00; C08F 10/06; C08K 5/09

(52) U.S. Cl. CPC C08F 10/02; B29C 48/022; C08F 10/06; C08K 5/09; B29K 2023/06; B29K 2023/12

(57) ABSTRACT

Processing parameters of polypropylene and/or polyethylene are adjusted by combining them with a non-fluorinated process aid. The process aid is an oleochemical derivative and/or a wax having a viscosity of from 10 cP to 100 cP. The wax is a branched ethylene-propylene copolymer. The processing parameter, e.g., pressure at the die, or volumetric output is adjusted for the polypropylene and/or polyethylene compared to the polypropylene and/or polyethylene without the non-fluorinated process aid at the same processing conditions. The mechanical properties of an extruded polymeric article including the non-fluorinated process aid are the same or are improved compared to the same composition without the non-fluorinated polymer processing aid or one that includes a fluorinated processing aid.

### FIELD OF THE INVENTION

The invention relates to a method of adjusting processing parameters of a polymer by combining the polymer with a non-fluorinated processing aid. The invention also relates to a polymer composition including the non-fluorinated processing aid.

### BACKGROUND

Fluoropolymers have long been used as polymer processing aids (PPA) in for various polymer applications, especially those which require high volume per time extrusion outputs and smooth surfaces. However, due to environmental and regulatory concerns, there is a need to identify a non-fluorinated PPA replacement. Typically, fluoropolymers are able to create a layer of molecules on the surface of the die during melt extrusion, leading to lower melt pressures and potentially higher throughputs and a commensurate reduced incidence of melt fracture. Generally, the process parameters that are affected by the PPAs are incidence of melt fracture, reduced pressure at the die at the same volumetric output, and increased volumetric output at the same pressure at the die compared to a polymer not including the PPA.

Many low weight average molecular weight (Mw) non-fluorinated PPAs work by effectively diluting the polymer, such as polypropylene, thus reducing the overall melt viscosity of the composition. Due to the lower melt viscosity these PPAs reduce the extrusion pressure at the die and thus increase productivity by permitting a higher extrusion volume output at the same die pressure. However, the mechanical properties of the resulting extruded articles may be negatively impacted, since the lower Mw component (the non-fluorinated processing aid) tends to lower the mechanical properties of the final part, such as tensile strength and heat resistance. Since the fluorinated PPAs act by migrating to the die surface, they do not affect the bulk properties in the same way that non-fluorinated PPAs do. The die coating mechanism manifests as a reduction in pressure at the die over time, compared to the initial pressure at start-up of the extrusion process.

Accordingly, there remains a need for non-fluorinated PPAs that can adjust the processing parameters of polymers without negatively affecting the mechanical properties of the resulting extruded polymeric article.

### SUMMARY

The inventors have found a method of adjusting the polymer processing parameters of a polymer by use of a non-fluorinated process aid comprising at least one of an oleochemical derivative, wax, or a combination thereof.

A method of adjusting a processing parameter of a polymer is provided. The method comprises a first step a) of combining i) a polymer comprising at least one of propylene or ethylene as a polymerized monomer; and ii) a non-fluorinated process aid to provide a polymer composition. The method also comprises a second step b) of processing the polymer composition at a processing condition to produce an extruded polymeric article. One or more mechanical properties of the extruded polymeric article remain the same or are improved as compared to a comparative polymer composition lacking the non-fluorinated process aid ii), but otherwise identical to the polymer composition.

The non-fluorinated process aid comprises at least one of an oleochemical derivative, a wax, or a combination thereof. The wax has a viscosity of from 10 cP to 100 cP at 149° C. as measured according to ASTM-3236-15 (2021), and comprises ethylene and propylene as polymerized monomers. The processing parameter is adjusted for the polymer composition compared to the polymer i) without the non-fluorinated process aid ii) at the processing condition.

A composition comprising i) a polymer comprising at least one of propylene or ethylene as a polymerized monomer; and ii) from 0.005 wt % to 10 wt %, by weight of the composition of a non-fluorinated process aid is also provided. The non-fluorinated processing aid comprises at least one of an oleochemical derivative, a wax, or a combination thereof. The wax has a viscosity of from 10 cP to 100 cP at 149° C. as measured according to ASTM-3236-15 and comprises propylene as a polymerized monomer.

### BRIEF DESCRIPTION OF THE DRAWINGS

FIG. 1 shows a plot of extruder throughput as a function of pressure at the die for certain embodiments of the invention and for comparative examples;

FIG. 2 shows a plot of pressure at the die as a function of extruder screw speed for certain embodiments of the invention and for comparative examples; and

FIG. 3 shows a plot of die pressure as a function of time since beginning of extrusion for certain embodiments of the invention and for comparative examples.

### DETAILED DESCRIPTION

This disclosure describes a method of adjusting processing parameters of a polymer by the use of non-fluorinated polymer processing aids (PPAs). The method improves the volumetric output of melt extrusion of polypropylene or polyethylene resins at the same pressure as the polymer without the non-fluorinated PPA, and also provides a reduced incidence of melt fracture at higher extrusion outputs, compared to the same polymer composition without the non-fluorinated PPA. At the same time, physical properties of the extruded part that include the non-fluorinated PPA are not adversely impacted compared to a comparative composition without the non-fluorinated PPA. As used herein, the comparative composition is understood to be an identical composition except for not including the non-fluorinated polymer processing aid. According to certain embodiments, the composition including the non-fluorinated polymer processing aid is substantially free of any fluorinated processing aids.

Specifically, the non-fluorinated PPAs of the invention include oleochemical derivatives such as fatty acid derivatives such as Plastaid-PAT from Fine Organics and/or waxes comprising propylene such as ethylene/propylene copolymer waxes. Polywax™ EP-1100 from NuCera is such a wax. When added to a polymer, in particular a polyolefin, these non-fluorinated PPAs exhibit the desirable feature of decreased pressure at the die over time. Therefore, without wishing to bound by any theory, these particular non-fluorinated PPAs are postulated to be able to form a thin layer of molecules on die metal surfaces, similar to fluoropolymer PPAs. Therefore, these additives surprisingly are able to provide lower extrusion pressure and increased extrusion productivity of low melt flow polypropylene resins and polyethylene resins without the “diluting” the polymer. As discussed above, this dilution of the polymer may adversely affect the physical properties of the final extruded part. These non-fluorinated PPAs are also able to mitigate or eliminate surface melt fracture, improving product quality for low MFR/MI polypropylene and polyethylene. The method is applicable to extrusion/film applications. The results are applicable to polyolefins, especially polypropylene, polyethylene and blends thereof. The method is especially useful for low MFR polypropylene resins and low MI polyethylene resins. Blends of the two non-fluorinated PPAs are also useful. The method and compositions are applicable to blends of polyolefins as well.

Compositions:

According to an embodiment, a composition comprising: i) a polymer comprising at least one of propylene or ethylene as a polymerized monomer; and ii) from 0.005 wt % to 10 wt %, by weight of the composition of a non-fluorinated process aid is provided. The non-fluorinated process aid comprises at least one of an oleochemical derivative, a wax, or a combination thereof. The wax has a viscosity of from 10 cP to 100 cP at 149° C. as measured according to ASTM-3236-15 and comprises propylene as a polymerized monomer.

According to an embodiment, the composition may include the non-fluorinated PPA at from 0.02 wt % to 5 wt %, based on the weight of the composition.

According to another embodiment, the tensile strength of the composition measured according to ASTM-D638-14 is at least 90% of a tensile strength of the comparative composition that lacks the non-fluorinated polymer processing aid. For example, the tensile strength of the composition as measured according to ASTM-D638-14 may be at least 80, 81, 82, 83, 84, 85, 86, 87, 88, 89, 90, 91, 92, 93, 94, 95, 96, 97, 98, 99, % of a tensile strength of the polymer i), wherein the polymer i) does not contain the non-fluorinated process aid ii). The tensile strength of the composition including the non-fluorinated process aid ii) may be the same as the comparative composition which is otherwise identical, but lacks the non-fluorinated process aid ii). The tensile strength may be improved compared to the comparative composition not including the non-fluorinated processing aid.

The polymer i) may be a blend of polypropylene and polyethylene. For example, the composition may include from 1 wt % to 99 wt % of polyethylene and/or a copolymer thereof and from 99 wt % to 1 wt % of polypropylene and/or a copolymer thereof, based on the total weight of the polyethylene and polypropylene in the composition. For example, the composition may include at least 1, 2, 5, 10, 15, 20, 30, 40, 50, 60, 70, 80, 85, 90, 95, 98, or at least 99 wt % of polyethylene and/or a copolymer thereof, based on the total weight polypropylene and polyethylene and copolymers thereof in the composition. The composition may include at most 99, 98, 95, 90, 85, 80, 70, 60, 50, 40, 30, 20, 15, 10, 5, 2, or at most 1 wt % polyethylene and/or a copolymer thereof, based on the total weight polypropylene and polyethylene and copolymers thereof in the composition. For example, the composition may include at least 1, 2, 5, 10, 15, 20, 30, 40, 50, 60, 70, 80, 85, 90, 95, 98, or at least 99 wt % of polypropylene and/or a copolymer thereof, based on the total weight of the polypropylene and polyethylene and copolymers thereof in the composition. The composition may include at most 99, 98, 95, 90, 85, 80, 70, 60, 50, 40, 30, 20, 15, 10, 5, 2, or at most 1 wt % polypropylene and/or a copolymer thereof, based on the total weight polypropylene and polyethylene and copolymers thereof.

The non-fluorinated process aid ii) may be a blend of the oleochemical derivative and the wax. For example, the composition may include from 1 wt % to 99 wt % of oleochemical derivative and from 99 wt % to 1 wt % of the wax, based on the total weight of the oleochemical derivative and the wax in the composition. For example, the non-fluorinated process aid ii) may include at most 99, 98, 95, 90, 85, 80, 70, 60, 50, 40, 30, 20, 15, 10, 5, 2, or at most 1 wt % of the oleochemical derivative, based on the total weight of the oleochemical derivative and the wax in the composition. For example, the non-fluorinated process aid ii) may include at least 1, 2, 5, 10, 15, 20, 30, 40, 50, 60, 70, 80, 85, 90, 95, 98, or at least 99 wt % of the wax, based on the total weight of the oleochemical derivative and the wax in the composition. The composition may include at most 99, 98, 95, 90, 85, 80, 70, 60, 50, 40, 30, 20, 15, 10, 5, 2, or at most 1 wt % of the wax, based on the total weight of the oleochemical derivative and the wax in the composition.

According to an embodiment, a tensile strength of the composition measured according to ASTM-D638-14 Type 1 bars with width of 13 mm, thickness of 3.2 mm and length of 165 mm using a distance between grips of 115 mm tested runs at 2 in/min, is at least 90% of a tensile strength of the polymer i), wherein the polymer i) does not contain the non-fluorinated process aid ii). For example, the tensile strength of the composition including the non-fluorinated PPA ii) may be at least 80, 81, 82, 83, 84, 85, 86, 87, 88, 89, 90, 91, 92, 93, 94, 95, 96, 97, 98k, 99, or 100% of the tensile strength of the same composition not including the non-fluorinated PPA ii).

Polymers i):

The polymers used in the invention can include polyolefins. Polyolefins can be prepared by any of the polymerization processes, which are in commercial use (e.g., a “high pressure” process, a slurry process, a solution process and/or a gas phase process) and with the use of any of the known catalysts (e.g., Ziegler Natta catalysts, chromium or Phillips catalysts, single site catalysts, metallocene catalysts, and the like). Non-limiting examples of polyolefins include polypropylenes and polyethylenes.

Polyethylenes can include homopolymers of ethylene or copolymers of ethylene with at least one alpha olefin (e.g., butene, hexene, octene and the like). Non-limiting examples of polyethylenes include low density polyethylene (LDPE), a linear low density polyethylene (LLDPE), a medium density polyethylene (MDPE), a high density polyethylene (HDPE), an ethylene copolymer, or blends thereof.

The polyolefin may also be prepared using any other method such as a combination of Ziegler-Natta and metallocene catalysts.

Ziegler-Natta Catalysts

Traditionally, catalyst systems used in bulk loop reactors for the commercial production (polymer production in the range of between 1 and up to 5 tons/hour and desirably between at least 1 ton to at least 50 tons/hour over a period of between at least about 5 days up to at least about 2 years) of polyethylene and polypropylene homopolymers and/or copolymers are commonly known as conventional Ziegler-Natta catalyst systems (hereafter may also be referred to as “Ziegler-Natta catalysts” or “Ziegler-Natta catalyst systems”). Non-limiting examples of conventional Ziegler-Natta catalysts systems can include a Ziegler-Natta catalyst, a support, one or more internal donors, and one or more external donors.

Conventional Ziegler-Natta catalysts are stereospecific complexes formed from a transition metal halide and a metal alkyl or hydride and can produce isotactic polypropylenes. The Ziegler-Natta catalysts are derived from a halide of a transition metal, such as titanium, chromium or vanadium with a metal hydride and/or metal alkyl, typically an organoaluminum compound as a co-catalyst. The catalyst can include a titanium halide supported on a magnesium compound. Ziegler-Natta catalysts, such as titanium tetrachloride (TiCl4) supported on an active magnesium dihalide, such as magnesium dichloride or magnesium dibromide are supported catalysts. Silica may also be used as a support. The supported catalyst may be employed in conjunction with a co-catalyst such as an alkylaluminum compound, for example, triethylaluminum (TEAL), trimethyl aluminum (TMA) and triisobutyl aluminum (TIBAL).

Conventional Ziegler-Natta catalysts may be used in conjunction with one or more internal electron donors. These internal electron donors are added during the preparation of the catalysts and may be combined with the support or otherwise complexed with the transition metal halide. A suitable Ziegler-Natta catalyst containing a diether-based internal donor compound is that available as Mitsui RK-100 and Mitsui RH-220, both manufactured by Mitsui Chemicals, Inc., Japan. The RK-100 catalyst additionally includes an internal phthalate donor. The Ziegler-Natta catalyst can be a supported catalyst. Suitable support materials include magnesium compounds, such as magnesium halides, dialkoxymagnesiums, alkoxymagnesium halides, magnesium oxyhalides, dialkylmagnesiums, magnesium oxide, magnesium hydroxide, and carboxylates of magnesium. Typical magnesium levels are from about 12% to about 20% by weight of catalyst. The RK-100 catalyst contains approximately 2.3% by weight titanium, with approximately 17.3% by weight magnesium. The RH-220 catalyst contains approximately 3.4% by weight titanium, with approximately 14.5% by weight magnesium.

Conventional Ziegler-Natta catalysts can also be used in conjunction with one or more external donors. Generally, such external donors act as stereoselective control agents to control the amount of atactic or non-stereoregular polymer produced during the reaction, thus reducing the amount of xylene solubles. Examples of external donors include the organosilicon compounds such as cyclohexylmethyl dimethoxysilane (CMDS), dicyclopentyl dimethoxysilane (CPDS) and diisopropyl dimethoxysilane (DIDS). External donors, however, may reduce catalyst activity and may tend to reduce the melt flow of the resulting polymer.

Metallocene Catalyst System

Other catalyst systems useful for polymerizing propylene and ethylene are based upon metallocenes. Metallocenes can be characterized generally as coordination compounds incorporating one or more cyclopentadienyl (Cp) groups (which may be substituted or unsubstituted and may be the same or different) coordinated with a transition metal through n bonding. The Cp groups may also include substitution by linear, branched or cyclic hydrocarbyl radicals and desirably cyclic hydrocarbyl radicals so as to form other contiguous ring structures, including, for example indenyl, azulenyl and fluorenyl groups. These additional ring structures can also be substituted or unsubstituted by hydrocarbyl radicals and desirably C1 to C20 hydrocarbyl radicals. Metallocene compounds may be combined with an activator and/or cocatalyst (as described in greater detail below) or the reaction product of an activator and/or cocatalyst, such as for example methylaluminoxane (MAO) and optionally an alkylation/scavenging agent such as trialkylaluminum compound (TEAL, TMA and/or TIBAL). Various types of metallocenes are known in the art, which may be supported. Typical support may be any support such as talc, an inorganic oxide, clay, and clay minerals, ion-exchanged layered compounds, diatomaceous earth, silicates, zeolites or a resinous support material such as a polyolefin. Specific inorganic oxides include silica and alumina, used alone or in combination with other inorganic oxides such as magnesia, titania, zirconia and the like. Non-metallocene transition metal compounds, such as titanium tetrachloride, are also incorporated into the supported catalyst component. The inorganic oxides used as support are characterized as having an average particle size ranging from 30-600 microns or from 30-100 microns, a surface area of 50-1,000 square meters per gram, or from 100-400 square meters per gram, a pore volume of 0.5-3.5 cc/g, or from about 0.5-2 cc/g.

Any metallocene may be used in the practice of the invention. As used herein unless otherwise indicated, “metallocene” includes a single metallocene composition or two or more metallocene compositions. Metallocenes are typically bulky ligand transition metal compounds generally represented by the formula: [L]ₘM[A]ₙ where L is a bulky ligand, A is a leaving group, M is a transition metal and m and n are such that the total ligand valency corresponds to the transition metal valency. The ligands L and A may be bridged to each other, and if two ligands L and/or A are present, they may be bridged. The metallocene compound may be full-sandwich compounds having two or more ligands L which may be cyclopentadienyl ligands or cyclopentadiene derived ligands or half-sandwich compounds having one ligand L, which is a cyclopentadienyl ligand or cyclopentadienyl derived ligand. The transition metal atom may be a Column 4, 5, or 6 transition metal and/or a metal from the lanthanide and actinide series of the Periodic Table. Non-limiting examples of metals include zirconium, titanium, and hafnium. Other ligands may be bonded to the transition metal, such as a leaving group. Non-limiting examples of ligands include hydrocarbyl, hydrogen or any other univalent anionic ligand. A bridged metallocene, for example, can be described by the general formula: RCpCp′MeQx. Me denotes a transition metal element and Cp and Cp′ each denote a cyclopentadienyl group, each being the same or different and which can be either substituted or unsubstituted, Q is an alkyl or other hydrocarbyl or a halogen group, x is a number and may be within the range of 1 to 3 and R is a structural bridge extending between the cyclopentadienyl rings. Metallocene catalysts and metallocene catalysts systems that produce isotactic polyolefins may be used. These systems include chiral, stereorigid metallocene catalysts that polymerize olefins to form isotactic polymers and are especially useful in the polymerization of highly isotactic polypropylene.

Metallocenes may be used in combination with some form of activator in order to create an active catalyst system. The term “activator” is defined herein to be any compound or component, or combination of compounds or components, capable of enhancing the ability of one or more metallocenes to polymerize olefins to polyolefins. Alklyalumoxanes such as methylalumoxane (MAO) are commonly used as metallocene activators. Generally, alkylalumoxanes contain about 5 to 40 of the repeating units. Alumoxane solutions, particularly methylalumoxane solutions, may be obtained from commercial vendors as solutions having various concentrations. There are a variety of methods for preparing alumoxane. (As used herein unless otherwise stated “solution” refers to any mixture including suspensions.)

Ionizing activators may also be used to activate metallocenes. These activators are neutral or ionic, or are compounds such as tri(n-butyl)ammonium tetrakis(pentaflurophenyl)borate, which ionize the neutral metallocene compound. Such ionizing compounds may contain an active proton, or some other cation associated with, but not coordinated or only loosely coordinated to, the remaining ion of the ionizing compound. Combinations of activators may also be used, for example, alumoxane and ionizing activators in combination.

Ionic catalysts for coordination polymerization comprised of metallocene cations activated by non-coordinating anions may be used. A method of preparation wherein metallocenes (bisCp and monoCp) are protonated by an anion precursor such that an alkyl/hydride group is abstracted from a transition metal to make it both cationic and charge-balanced by the non-coordinating anion is suitable. Suitable ionic salts include tetrakis-substituted borate or aluminum salts having fluorided aryl-constituents such as phenyl, biphenyl and napthyl.

The term “noncoordinating anion” (“NCA”) means an anion which either does not coordinate to said cation or which is only weakly coordinated to said cation thereby remaining sufficiently labile to be displaced by a neutral Lewis base. “Compatible” noncoordinating anions are those which are not degraded to neutrality when the initially formed complex decomposes. Further, the anion will not transfer an anionic substituent or fragment to the cation so as to cause it to form a neutral four coordinate metallocene compound and a neutral by-product from the anion.

The use of ionizing ionic compounds not containing an active proton but capable of producing both the active metallocene cation and a noncoordinating anion is also known. An additional method of making the ionic catalysts uses ionizing anion precursors which are initially neutral Lewis acids but form the cation and anion upon ionizing reaction with the metallocene compounds, for example the use of tris(pentafluorophenyl) borane. Ionic catalysts for addition polymerization can also be prepared by oxidation of the metal centers of transition metal compounds by anion precursors containing metallic oxidizing groups along with the anion groups.

Where the metal ligands include halogen moieties (for example, bis-cyclopentadienyl zirconium dichloride) which are not capable of ionizing abstraction under standard conditions, they can be converted via known alkylation reactions with organometallic compounds such as lithium or aluminum hydrides or alkyls, alkylalumoxanes, Grignard reagents, etc. In situ processes of the reaction of alkyl aluminum compounds with dihalo-substituted metallocene compounds prior to or with the addition of activating anionic compounds may be used.

Suitable methods for supporting ionic catalysts comprising metallocene cations and NCA are known. When using the support composition, these NCA support methods can include using neutral anion precursors that are sufficiently strong Lewis acids to react with the hydroxyl reactive functionalities present on the silica surface such that the Lewis acid becomes covalently bound. Additionally, when the activator for the metallocene supported catalyst composition is an NCA, desirably the NCA is first added to the support composition followed by the addition of the metallocene catalyst. When the activator is MAO, desirably the MAO and metallocene catalyst are dissolved together in solution. The support is then contacted with the MAO/metallocene catalyst solution. Other methods and order of addition will be apparent to those skilled in the art.

The polyolefin may be formed by placing one or more olefin monomer (e.g., ethylene, propylene) alone or with other monomers in a suitable reaction vessel in the presence of a catalyst (e.g., Ziegler-Natta, metallocene, etc.) and under suitable reaction conditions for polymerization thereof. Any suitable equipment and processes for polymerizing the olefin into a polymer may be used. For example, such processes may include solution phase, gas phase, slurry phase, bulk phase, high pressure processes or combinations thereof.

Polyolefins can be formed by a gas phase polymerization process. One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from 100 psig to 500 psig, or from 200 psig to 400 psig, or from 250 psig to 350 psig. The reactor temperature in a gas phase process can be from 30° C. to 120° C. or from 60° C. to 115° C. or from 70° C. to 110° C. or from 70° C. to 95° C.

Polypropylene

The polypropylene resin may include polypropylene homopolymer, random copolymer, impact copolymers, and combinations thereof. The polypropylene resin may be produced with Ziegler Natta catalysts or metallocene catalysts. Polypropylenes include homopolymers of propylene, copolymers of propylene and other olefins, and terpolymers of propylene, ethylene, and dienes. The polypropylene may be a reactor grade (i.e., as produced from the reactor) or may be a tailored polypropylene, such as a controlled rheology or “vis-broken” grade. A controlled rheology grade polypropylene (CRPP) or “vis-broken” grade polypropylene is one that has been further processed (e.g., through a degradation process) to produce a polypropylene polymer with a targeted melt flow index (MFI), targeted molecular weight, and/or a narrower molecular weight distribution than the starting polypropylene.

According to an embodiment, the polymer i) may comprise at least one of polypropylene homopolymer, isotactic polypropylene, syndiotactic polypropylene, random copolymers of ethylene and propylene, or combinations thereof. The polymer i) may comprises propylene as a polymerized monomer and further comprises, as a polymerized monomer, up to 6 wt % by weight of the polymer i) of at least one of ethylene, butene, pentene, hexene, or a combination thereof. The polymer i) may comprise polypropylene having a melt flow index of from 0.5 to 10 g/10 minutes as measured according to ASTM-D1238-20. For example, the melt flow index pf the polypropylene may be from 0.1 to 5 g/10 minutes or from 1 to 8 g/10 minutes. According to various embodiments, the melt flow index of the polypropylene may be at least 0.5, 0.6, 0.7, 0.8, 0.9, 1, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0, 5.2, 5.4, 5.6, 5.8, 6.0, 6.2, 6.4, 6.6, 6.8, 7.0, 7.2, 7.4, 7.6, 7.8, 8.0, 8.2, 8.4, 8.6, 8.8, 9.0, 9.2, 9.4, 9.6 or at least 9.8 g/10 minutes as measured according to ASTM-D1238-20. According to various embodiments, the melt flow index of the polypropylene may be at most 10.0, 9.8, 9.6, 9.4, 9.2, 9.0, 8.8, 8.6, 8.4, 8.2, 8.0, 7.8, 7.6, 7.4, 7.2, 7.0, 6.8, 6.6, 6.4, 6.2, 6.0, 5.8, 5.6, 5.4, 5.2, 5.0, 4.8, 4.6, 4.4, 4.2, 4.0, 3.8, 3.6, 3.4, 3.2, 3.0, 2.8, 2.6, 2.4, 2.2, 2.0, 1.8, 1.6, 1.4, 1.2, 1.0, 0.9, 0.8, 0.7, 0.6, 0.5, 0.4, 0.3, or at most 0.2 g/10 minutes as measured according to ASTM-D1238-20.

The polypropylene can be produced using any catalyst known in the art, such as chromium catalysts, Ziegler-Natta catalysts and/or metallocene catalysts as discussed above.

Polyethylene

According to an embodiment, the polymer i) comprises polyethylene having a melt flow index of from 0.1 to 10 g/10 minutes as measured according to ASTM-D1238-20. For example, the melt flow index may be from 0.1 to 10 g/10 minutes, or from 1 to 10 g/10 minutes using a 5 kg weight. According to various embodiments, the melt flow index of the polyethylene may be at least 0.5, 0.6, 0.7, 0.8, 0.9, 1, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0, 5.2, 5.4, 5.6, 5.8, 6.0, 6.2, 6.4, 6.6, 6.8, 7.0, 7.2, 7.4, 7.6, 7.8, 8.0, 8.2, 8.4, 8.6, 8.8, 9.0, 9.2, 9.4, 9.6 or at least 9.8 g/10 minutes as measured according to ASTM-D1238-20 using a 5 kg weight. According to various embodiments, the melt flow index of the polyethylene may be at most 10.0, 9.8, 9.6, 9.4, 9.2, 9.0, 8.8, 8.6, 8.4, 8.2, 8.0, 7.8, 7.6, 7.4, 7.2, 7.0, 6.8, 6.6, 6.4, 6.2, 6.0, 5.8, 5.6, 5.4, 5.2, 5.0, 4.8, 4.6, 4.4, 4.2, 4.0, 3.8, 3.6, 3.4, 3.2, 3.0, 2.8, 2.6, 2.4, 2.2, 2.0, 1.8, 1.6, 1.4, 1.2, 1.0, 0.9, 0.8, 0.7, 0.6, 0.5, 0.4, 0.3, or at most 0.2 g/10 minutes as measured according to ASTM-D1238-20 using a 5 kg weight.

For the purposes of the present application, the terms “polyethylene” or “polyethylene polymer” are synonymous and are used to denote ethylene homopolymer as well as ethylene copolymers. If the polyethylene is a copolymer, the comonomer can be any alpha-olefin i.e. any 1-alkylene comprising from 2 to 12 carbon atoms, for example, ethylene, propylene, 1-butene, and 1-hexene. The copolymer can be an alternating, periodic, random, statistical or block copolymer. Preferably, the polyethylene used in the invention is a homopolymer or a copolymer of ethylene and hexene and/or butene.

The polyethylene can be produced using any catalyst known in the art, such as chromium catalysts, Ziegler-Natta catalysts and/or metallocene catalysts as discussed above.

Non-Fluorinated Processing Aids ii)

According to an embodiment, the polymer composition comprises from 0.005 wt % to 10 wt % of the non-fluorinated process aid (PPA) ii), by weight of the polymer composition. According to an embodiment, the polymer composition comprises from 0.02 wt % to 5 wt %, by weight of the composition, of the non-fluorinated process aid ii). According to various embodiments the polymer composition may comprise at least 0.005, 0.006, 0.007. 0.008, 0.009, 0.01, 0.015, 0.02, 0.025, 0.03, 0.035, 0.04, 0.045, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, or at least 9 wt % of the non-fluorinated process aid (PPA) ii), by weight of the polymer composition. According to various embodiments, the polymer composition may comprise at most 10, 9.9, 9.8, 9.7, 9.6, 9.5, 9.4, 9.3, 9.2, 9.1, 9, 8.9, 8.8, 8.7, 8.6, 8.5, 8.4, 8.3, 8.2, 8.1, 8, 7.75, 7.5, 7.25, 7, 6.75, 6.5, 6.25, 6, 5.75, 5.5, 5.25, 5, 4, 3, 2 or at most 1 wt % of the non-fluorinated process aid (PPA) ii), by weight of the polymer composition.

The non-fluorinated PPA ii) comprises, consists of, or consists essentially of an oleochemical derivative, a wax, or a combination thereof.

Oleochemical Derivatives:

The non-fluorinated process aid ii) may comprise, consist of, or consist essentially of an oleochemical derivative or a blend of oleochemical derivatives. The non-fluorinated process aid ii) may therefore be derivative of a fat or an oil. The fat or oil may be synthetic or derived from a plant or animal. The oleochemical derivative may comprise a fatty acid derivative or blend thereof. The fatty acid derivative may be a derivative of any saturated, partially saturated or unsaturated fat, oil, or fatty acid. The fat, oil or fatty acid may have from 4 to 40 carbon atoms. Advantageously, the melting point or softening point of the oleochemical derivative used as the non-fluorinated process aid ii) is at or below the melting point of the polymer i). In particular, the oleochemical derivative that is used as the non-fluorinated process aid ii) may comprise, consist of, or consist essentially of Plastaid-PAT from Fine Organic Industries.

Wax:

The non-fluorinated PPA ii) may comprise, consist of, or consist essentially of a wax having a viscosity of from 10 cP to 100 cP at 140° C. as measured according to ASTM-3236-15. The wax may have a weight average molecular weight Mw of from 300 to 1500 g/mol, or from 900 to 1300 g/mol, or from 1000 to 1200 g/mol. The wax may have a number average molecular weight Mn of from 300 to 1500 g/mol, or from 900 to 1300 g/mol, or from 1000 to 1200 g/mol. The wax advantageously has a relatively narrow polydispersity Mw/Mn of from 1 to 1.2 or from 1 to 1.1. The wax may have propylene branches and controlled branching. The wax comprises, consists of, or consists essentially of propylene as a polymerized monomer. The wax may be a copolymer of ethylene and propylene. The wax may comprise from 95 to 100% by weight of propylene as a polymerized monomer, based on the total weight of the wax. The wax may have a structure:

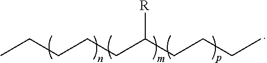

The Mw of the wax may be at least 250, 300, 350, 400, 450, 500, 550, 600, 650, 700, 750, 800, 850, 900, 950, or at least 1000 g/mol. The Mw of the wax may be at most 2500, 2400, 2300, 2200, 2100, 2000, 1900, 1800, 1700, 1600, 1500, 1450, 1400, 1350, 1300, 1250, 1200, or at most 1150 g/mol. The Mn of the wax may be at least 250, 300, 350, 400, 450, 500, 550, 600, 650, 700, 750, 800, 850, 900, 950, or at least 100 g/mol. The Mn of the wax may be at most 2500, 2400, 2300, 2200, 2100, 2000, 1900, 1800, 1700, 1600, 1500, 1450, 1400, 1350, 1300, 1250, 1200, or at most 1150 g/mol.

R may be a branched or straight chained alkyl group. R may be a methyl group.

In particular, the wax may comprise, consist of, or consist essentially of POLYWAX™ EP1100 from NuCera.

Other Additives:

The polymer compositions of the present invention can further include at least one additive. Non-limiting examples of additives include an antiblocking agent, an antistatic agent, an antioxidant, a neutralizing agent, a blowing agent, a crystallization aid, a dye, a flame retardant, a filler, an impact modifier, a mold release agent, an oil, another polymer, a pigment, a processing agent, a reinforcing agent, a nucleating agent, a clarifying agent, a slip agent other than a PPA, a flow modifier other than a PPA, a stabilizer, an UV resistance agent, and combinations thereof. Additives are available from various commercial suppliers. Non-limiting examples of commercial additive suppliers include BASF (Germany), Dover Chemical Corporation (U.S.A.), AkzoNobel (The Netherlands), Sigma-Aldrich® (U.S.A.), Atofina Chemicals, Inc., and the like.

Methods

Methods of combining the polymer i) with the non-fluorinated processing aid include a customary mixing machine, in which the polymer i) and non-fluorinated PPA can be melted and mixed with the optional additives. Suitable machines are known to those skilled in the art. Non-limiting examples include mixers, kneaders and extruders. In certain aspects, the process can be carried out in an extruder by introducing the non-fluorinated PPA during the polymer processing. Non-limiting examples of extruder can include single-screw extruders, contrarotating and co-rotating twin-screw extruders, planetary-gear extruders, ring extruders, or co-kneaders. Additionally, the polymer i) and the non-fluorinated PPA can also be dry-blended and the resulting polymer blend used in typical polymer processes (e.g., blown film extrusion, foam extrusion, sheet extrusion-thermoforming, etc.) In some embodiments, the non-fluorinated PPA can be obtained and mixed with the polymer i) and one or more optional additives to produce the polymer blend of the present invention. The polymer i) and the non-fluorinated PPA, or blend thereof can be subjected to an elevated temperature for a sufficient period of time during blending. The blending temperature can be above the softening point of the polymer i).

According to an embodiment, the non-fluorinated PPA can be incorporated or provided in the form of a masterbatch. As is known in the art, a masterbatch is a composition of a relatively high concentration one or more additives in a carrier resin that is used to proportion he additive(s) accurately into a large bulk of a polymer. If used, the masterbatch may comprise polyethylene, polypropylene and/or the specific polymer i) as the carrier. According to an embodiment, the masterbatch may include from 1 wt % to 80 wt % of the non-fluorinated PPA, based on the total weight of the masterbatch.

Processing Parameters and Processing Conditions:

The compositions and methods as disclosed herein are especially suitable for sheet and film extrusions of low MFI polypropylene and polyethylenes and combinations thereof. In particular, the inventors have found that compositions of the polymer i) (especially polyethylene and polypropylene) including the specific non-fluorinated PPAs ii) disclosed herein provide the following measurable effects compared to compositions of the polymers i) not including the non-fluorinated PPA ii). It is important to note here that the comparisons may be with respect to an otherwise identical comparative composition that does not include the non-fluorinated PPA. According to certain embodiments the polymer may be substantially free of fluorinated PPA. The comparative composition is understood to be identical in composition to the inventive composition, except for not including the non-fluorinated process aid ii).

Polypropylene/polyethylene formulations including the oleochemical derivative and/or the wax can reduce or eliminate melt fractures at the same extrusion volume per time compared to a formulation not including the non-fluorinated PPA ii).

Extrusion of polypropylene and/or polyethylene formulations containing the non-fluorinated PPA ii) can be done with lower melt pressure and higher extrusion throughputs compared to the same polypropylene and/or polyethylene formulations not containing the non-fluorinated PPA ii).

A method of adjusting a processing parameter of a polymer is provided. The method comprises:
a) combining;
i) a polymer comprising at least one of propylene or ethylene as a polymerized monomer; and
ii) a non-fluorinated process aid comprising at least one of an oleochemical derivative; and/or a wax having a viscosity of from 10 cP to 100 cP at 149° C. as measured according to ASTM-3236-15, the wax comprising propylene as a polymerized monomer; or a combination thereof; to provide a polymer composition; and
b) processing the polymer composition at a processing condition;
wherein the processing parameter is adjusted for the polymer composition compared to a comparative polymer composition lacking the non-fluorinated process aid ii), but otherwise identical to the polymer composition, at the processing condition.

According to an embodiment, the processing parameter is output volume per hour and the processing condition is pressure at a die, and the output volume for the polymer composition is higher compared to the comparative polymer composition lacking the non-fluorinated process aid ii) at the same pressure at the die. For example, the output volume per hour may be 10% higher for the same pressure at the die. The output volume may be 1%, 2%, 3%, 4%, 5%, 6%, 7%, 8%, 9%, 10%, 11%, 12%, 13%, 14%, 15%, 16%, 17%, 18%, 20% or higher for the composition including the non-fluorinated PPA ii) at the same pressure at the die, compared to a composition not including the non-fluorinated PPA ii).

According to another embodiment, the processing parameter is pressure at a die and the processing condition is output volume per hour, and the pressure at a die is lower for the polymer composition compared to the comparative polymer composition lacking the non-fluorinated process aid ii) at the same output volume per hour. For example, the pressure at the die at may be 10% lower for the same output volume per hour. The pressure at the die may be 1%, 2%, 3%, 4%, 5%, 6%, 7%, 8%, 9%, 10%, 11%, 12%, 13%, 14%, 15%, 16%, 17%, 18%, 20% or lower for the composition including the non-fluorinated PPA ii) at the same output volume per hour, compared to the comparative composition lacking the non-fluorinated PPA ii).

According to another embodiment, the processing parameter is melt fracture and the processing condition is output volume per hour, and the melt fracture is reduced or absent for the polymer composition compared to the comparative polymer composition lacking the non-fluorinated process aid ii) at the same output volume per hour. According to an embodiment, the processing parameter is melt fracture and the processing condition is pressure at a die, and the melt fracture is reduced or absent for the polymer composition compared to the comparative polymer composition lacking the non-fluorinated process aid ii) at the same pressure at the die.

According to an embodiment, the processing parameter is drop in pressure at a die since beginning of an extrusion and the processing condition is time since the beginning of the extrusion, and the drop in pressure at the die is higher for the polymer composition compared to the comparative polymer composition lacking the non-fluorinated process aid ii) at the same time since the beginning of the extrusion. For example, the die pressure may drop 10% after the first hour of extrusion for a composition including the non-fluorinated PPA ii) and the pressure at the dies may not drop at all for the comparative polymer composition lacking the non-fluorinated PPA ii).

### Examples

All the additives evaluated in this study are listed in Table 1. The base resin used was a polypropylene, 4252 available from TotalEnergies. The additives were used at 1 wt % loading for all the formulations except for the comparative example 2 which is the same polypropylene base resin, but incorporates 0.1 wt % FX5911, a fluorinated PPA. The blend with 1% boron nitride powder resulted in an unacceptable amount of white specks in the extrudates, and thus 0.1% boron nitride powder was utilized instead for the extrusion study. During experiments, the Licocene PPA300 was determined to be too soft to blend with the base resin.

TABLE 1
Compositions

| | Base polymer | PPA | Comment |
|---|---|---|---|
| Comparative | TotalEnergies 4252 | none | Successful run |
| Example 1 | | | |
| Comparative | TotalEnergies 4252 | 0.1 wt % Fluorinated PPA | Successful run |
| Example 2 | | (FX5911) | |
| Comparative | TotalEnergies 4252 | 1.0 wt % Metallocene C2 wax | Successful run |
| Example 3 | | (EXEREX 30200B) | |
| Example 1 | TotalEnergies 4252 | 1.0 wt % C2-C3 copolymer wax | Successful run |
| | | (Polywax EP1100) | |
| Example 2 | TotalEnergies 4252 | 1.0 wt % Oleo derivative | Successful run |
| | | (Plastaid-PAT) | |
| Comparative | TotalEnergies 4252 | 1.0 wt % high Mw siloxane | Successful run |
| Example 4 | | polymer | |
| | | (MB25-501MB) | |
| Comparative | TotalEnergies 4252 | 1.0 wt % Metallocene C2-C3 | Successful run |
| Example 5 | | wax | |
| | | (Licocene) | |
| Comparative | TotalEnergies 4252 | 1.0 wt % Boron Nitride powder | White specks |
| Example 6 | | | |
| Comparative | TotalEnergies 4252 | 0.1 wt % Boron Nitride powder | Successful run |
| Example 7 | | | |

The baseline standard 4252 pellets (without PPA) were extruded first, followed by formulations containing FX5911 and other additives. To minimize cross-contamination, neat 4252 pellets were dropped in to purge the extruder for at least 30 minutes before switching to the next formulation. For each formulation, the extrusion was allowed to reach steady state for at least 30 minutes before recording the extrusion pressures and extrusion outputs. The extrusion data collected at different screw speeds (20 rpm, 40 rpm, 60 rpm, 80 rpm, and 100 rpm) are shown in the figures. Like FX5911, all the polyolefin wax, oleo-derivative, and siloxane additives were able to significantly lower 4252 extrusion melt pressure at the same extrusion outputs compared the composition not including the PPAs.

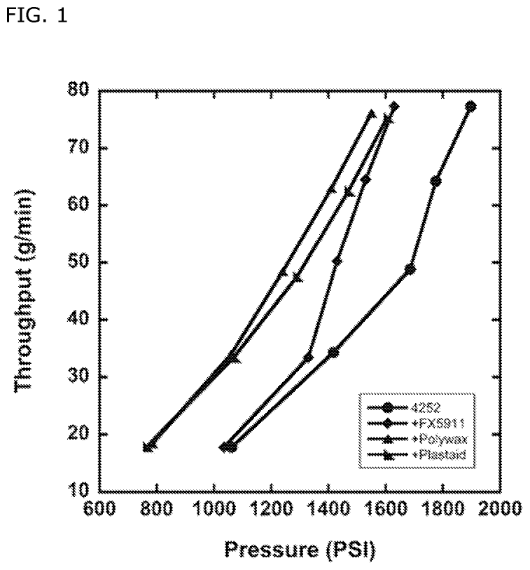

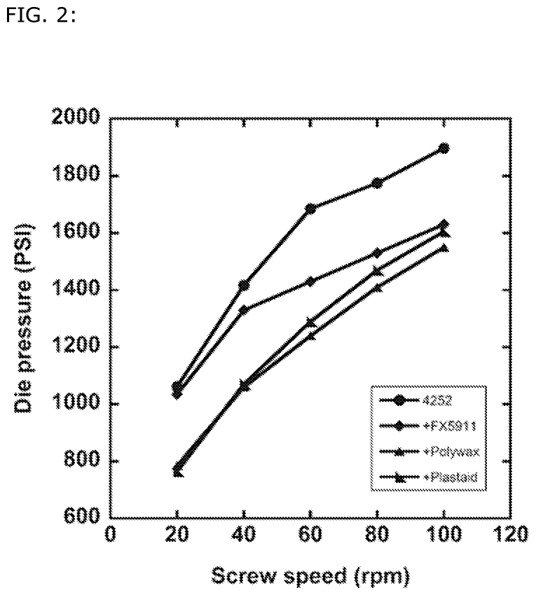

The extrusion throughputs were plotted against the melt pressures as shown in FIG. 1 for all the compositions as shown in Table 1. FIG. 1 demonstrates that under similar extrusion pressures, the polypropylene 4252 resin formulated with FX5911, polyolefin waxes, oleo-derivatives, and siloxane additives were able to achieve higher outputs at the same pressure at the die compared to the formulations not including these PPAs. In other words, if extrusion productivity was limited by high melt pressure of the low melt flow rate (MFR) 4252, customers should be able to speed up their extruder with the 4252 materials formulated with the above PPA additives. Boron nitride was found not to be an effective PPA for improving 4252 extrusion process. FIG. 2 shows the extrusion results as pressure at the die plotted as a function of pressure at the die. As seen in FIG. 2, the compositions including the PPAs had lower pressure at the die at the same screw speed compared to the resin not including a PPA.

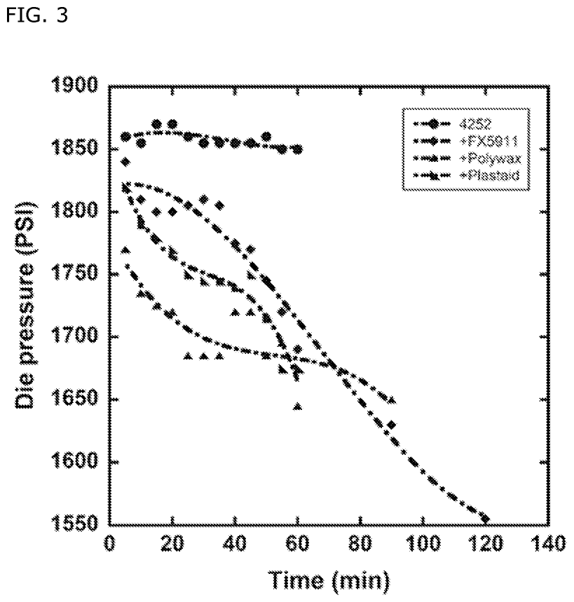

Finally, in addition to increasing the output volume and reducing pressure at the die, it is important that PPAs do not reduce viscosity via a mechanism of diluting the polymer and thereby reducing the mechanical properties as well. It therefore is desirable that the PPA have the property of reducing the pressure at a die since the beginning of the extrusion. Without wishing to be bound by any particular theory, this drop in pressure over time maybe indicative of the PPA migrating to the die interior, thus providing less resistance to flow. In order to study this effect, the standard fluorinated additive (FX5911), a polyolefin wax (Polywax EP1100), an oleo-derivative (Plastaid-PAT), a siloxane masterbatch (MB25-501) and a stearamide (EBS) were used as the PPA additives and extrusions were performed. The results are plotted in FIG. 3 as pressure at the die for the time since beginning the extrusion of each composition. As expected, when extruding the standard 4252 without a PPA additive, the melt pressure remained constant over time. When 4252 was formulated with 1000 ppm fluoropolymer PPA FX5911, the melt pressure was comparable to the neat 4252 in the beginning of the extrusion, indicating that FX5911 did not affect the melt viscosity of 4252. The extrusion melt pressures gradually reduced over time, likely indicative that the fluoropolymer built a layer of molecules on the metal surfaces of the die. This is the typical mechanism of fluoropolymer PPA for improving polymer extrusion processes. The 4252 formulated with Plastaid-PAT had the exact the same effect on the melt pressure over time as the fluoropolymer FX5911, indicating that it likely built a layer of molecules on the metal surfaces of the die and therefore had the desirable property of not diluting the polymer. 4252 with Polywax EP1100 showed a lower melt viscosity in the beginning of the extrusion apparently because the Polywax EP11 diluted the 4252 melt viscosity and thus lowered melt pressure. However, the melt pressure of the composition including the Polywax EP1100 demonstrated a clear downtrend over time, indicating that small amounts of the Polywax EP1100 molecules were able to coat onto metal surfaces similar to the fluoropolymer PPA and therefore the dilution effect was expected to be small.

On the other hand, the comparative examples that included EBS and MB25-formulated with 4252 as the PPA extrusions did not show any noticeable trend of reduced melt pressure over time. MB25 lowered the 4252 extrusion melt pressure likely due to the fact that MB25 carrier had a very low melt flow rate and therefore is diluting the polymer, not targeting the die surface to reduce flow resistance.

In summary, based on the results, one of ordinary skill would understand that Plastaid-PAT is an exemplary non-fluorinated PPA candidate for FX5911 fluorinated PPA replacement. Polywax EP-1100 would also be understood to be a good candidate, because the composition including it also showed a decrease in pressure at the die over time since the beginning of the extrusion.

What is claimed is:

1. A method of adjusting a processing parameter of a polymer, comprising:
a) combining
i) a polymer comprising at least one of propylene or ethylene as a polymerized monomer; and
ii) a non-fluorinated process aid comprising at least one of:
an oleochemical derivative;
a wax having a viscosity of from 10 cP to 100 cP at 149° C. as measured according to ASTM-3236-15, the wax comprising propylene as a polymerized monomer; or
a combination thereof; to provide the polymer composition; and
b) processing the polymer composition at a processing condition to produce an extruded polymeric article;
wherein the processing parameter is adjusted at the processing condition for the polymer composition compared to a comparative polymer composition; and
wherein one or more mechanical properties of the extruded polymeric article remain the same or are improved as compared to the comparative polymer composition;
wherein the comparative polymer composition lacks the non-fluorinated process aid ii), but is otherwise identical to the polymer composition.

2. The method of claim 1, wherein the processing parameter is output volume per hour and the processing condition is pressure at a die, and the output volume for the polymer composition is higher compared to the comparative polymer composition at the same pressure at the die.

3. The method of claim 1, wherein the processing parameter is pressure at a die and the processing condition is output volume per hour, and the pressure at the die is lower for the polymer composition compared to the comparative polymer composition at the same output volume per hour.

4. The method of claim 1, wherein the processing parameter is melt fracture and the processing condition is extrusion output, and the melt fracture is reduced or absent for the polymer composition compared to the comparative polymer composition at the same extrusion output.

5. The method of claim 1, wherein the processing parameter is melt fracture and the processing condition is output volume per hour, and the melt fracture is reduced or absent for the polymer composition compared to the comparative polymer composition at the same output volume per hour.

6. The method of claim 1, wherein the processing parameter is drop in pressure at a die since beginning of an extrusion and the processing condition is time since the beginning of the extrusion, and the drop in pressure at the die is higher for the polymer composition compared to the comparative polymer composition at the same time since the beginning of the extrusion.

7. The method of claim 1, wherein the non-fluorinated process aid ii) comprises the oleochemical derivative.

8. The method of claim 7, wherein the oleochemical derivative comprises a fatty acid derivative.

9. The method of claim 7, wherein the oleochemical derivative comprises Plastaid-PAT from Fine Organic Industries.

10. The method of claim 1, wherein the non-fluorinated process aid ii) comprises the wax having a viscosity of from 10 cP to 100 cP at 140° C. as measured according to ASTM-3236-15(2021), the wax comprising ethylene and propylene as polymerized monomers.

11. The method of claim 10, wherein the wax has a weight average molecular weight Mw of from 300 to 1500 g/mol and a number average molecular weight Mn of from 300 to 1500 g/mol.

12. The method of claim 10, wherein the wax has a polydispersity Mw/Mn of from 1 to 1.2.

13. The method of claim 10, wherein the wax comprises 95 to 100% by weight of propylene as a polymerized monomer.

14. The method of claim 10, wherein the wax has structure: 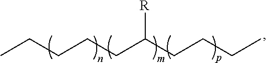
wherein R is a branched or straight chained alkyl group.

15. The method of claim 10, wherein the non-fluorinated process aid ii) comprises Polywax EP1100 from NuCera.

16. The method of claim 1, wherein the polymer i) comprises polypropylene having a melt flow index of from 0.5 to 10 g/10 minutes as measured according to ASTM-D1238-20.

17. The method of claim 1, wherein the polymer i) comprises polyethylene having a melt flow index of from 0.1 to 10 g/10 minutes as measured according to ASTM-D1238-20.

18. The method of claim 1, wherein the polymer composition comprises from 0.005 wt % to 10 wt % of the nonfluorinated process aid ii), by weight of the polymer composition.

19. The method of claim 1, wherein the polymer i) comprises at least one of polypropylene homopolymer, isotactic polypropylene, syndiotactic polypropylene, random copolymers of ethylene and propylene, or combinations thereof.

20. The method of claim 1, wherein the polymer i) comprises propylene as a polymerized monomer and further comprises, as a polymerized monomer, up to 6 wt % by weight of the polymer i) of at least one of ethylene, butene, pentene, hexane, or a combination thereof.

21. A composition comprising:
i) a polymer comprising at least one of propylene or ethylene as a polymerized monomer; and
ii) from 0.005 wt % to 10 wt %, by weight of the composition of a non-fluorinated process aid comprising at least one of an oleochemical derivative; a wax having a viscosity of from 10 cP to 100 cP at 149° C. as measured according to ASTM-3236-15, the wax comprising propylene as a polymerized monomer; or a combination thereof.

22. The composition of claim 21, wherein the non-fluorinated process aid ii) comprises the oleochemical derivative.

23. The composition of claim 22, wherein the oleochemical derivative comprises a fatty acid derivative.

24. The composition of claim 22, wherein the oleochemical derivative comprises Plastaid-PAT from Fine Organic Industries.

25. The composition of claim 21, wherein the non-fluorinated process aid ii) comprises the wax.

26. The composition of claim 25, wherein the wax has a polydispersity Mw/Mn of from 1 to 1.2.

27. The composition of claim 25, wherein the wax comprises 95 to 100% by weight of propylene as a polymerized monomer.

28. The method of claim 25, wherein the wax has structure: 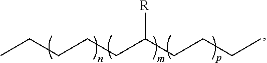
wherein R is a branched or straight chained alkyl group.

29. The composition of claim 25, wherein the wax comprises Polywax EP1100 from NuCera.

30. The composition of claim 21, comprising from 0.02 wt % to 5 wt % of the non-fluorinated process aid ii), by weight of the composition.

31. The composition of claim 21, wherein the polymer i) comprises at least one of polypropylene homopolymer, isotactic polypropylene, syndiotactic polypropylene, random copolymers of ethylene and propylene, or combinations thereof; and has a melt flow rate of 0.5 g/10 min to 10 g/10 min as measured according to ASTM-D1238-20.

32. The composition of claim 21, wherein the polymer i) comprises propylene as a polymerized monomer and further comprises, as a polymerized monomer, up to 6 wt % by weight of the polymer i) of at least one of ethylene, butene, pentene, hexane, or a combination thereof.

33. The composition of claim 21, wherein the polymer i) comprises polyethylene having a melt flow rate of 0.1 g/10 min to 10 g/10 min as measured according to ASTM-D1238-20.

34. The composition of claim 21, wherein a tensile strength of the composition measured according to ASTM-D638-14 Type 1 bars with width of 13 mm, thickness of 3.2 mm and length of 165 mm using a distance between grips of 115 mm tested runs at 2 in/min, is at least 90% of a tensile strength of the polymer i), wherein the polymer i) does not contain the non-fluorinated process aid ii).
